(19) United States
(12) Patent Application Publication
(10) Pub. No.: US 2016/0125436 A1
(43) Pub. Date: May 5, 2016

(54) COMPUTER-READABLE MEDIUM, SYSTEM AND METHOD

(71) Applicant: FUJITSU LIMITED, Kawasaki-shi (JP)

(72) Inventors: Yuhei UMEDA, Kawasaki (JP); Yoshinobu MATSUI, Kawasaki (JP); Kazuhiro Matsumoto, Kawasaki (JP); Hirokazu ANAI, Hachioji (JP); Isamu WATANABE, Kawasaki (JP)

(73) Assignee: FUJITSU LIMITED, Kawasaki-shi (JP)

(21) Appl. No.: 14/927,183

(22) Filed: Oct. 29, 2015

(30) Foreign Application Priority Data
Oct. 31, 2014 (JP) 2014-223456

(51) Int. Cl. G06Q 30/02

(52) U.S. Cl. CPC G06Q 30/0202

(57) ABSTRACT

A system includes: circuitry configured to receive a condition regarding a constraint condition of a product, acquire past requirement values for the product, predict, for each of a plurality of periods, requirement value for the product by calculating the requirement value for each of the plurality of periods based on the acquired past requirement values, generate, based on the predicted requirement value for each of the plurality of periods, a probability distribution of the constraint condition for each of a plurality of requested arrangements each of which indicates requested quantities of the product for each of the plurality of periods, and output at least one of the plurality of requested arrangements, based on the generated probability distribution and the received condition regarding the constraint condition.

### CROSS-REFERENCE TO RELATED APPLICATION

This application is based upon and claims the benefit of priority of the prior Japanese Patent Application No. 2014-223456, filed on Oct. 31, 2014, the entire contents of which are incorporated herein by reference.

### FIELD

The embodiments discussed herein are related to a computer-readable medium, a system and a method.

### BACKGROUND

There is a technique for predicting a demand quantity for a product and obtaining an order quantity plan that allows reduction of a probability of out-of-stock occurrence, that is, a probability that the product is sold out, to a predetermined value or lower.

As examples of related art, Japanese Laid-open Patent Publication No. 2003-316938, Japanese Laid-open Patent Publication No. 2004-171180, and Japanese Laid-open Patent Publication No. 2002-352123 are known.

### SUMMARY

According to an aspect of the invention, a system includes: circuitry configured to receive a condition regarding a constraint condition of a product, acquire past requirement values for the product, predict, for each of a plurality of periods, requirement value for the product by calculating the requirement value for each of the plurality of periods based on the acquired past requirement values, generate, based on the predicted requirement value for each of the plurality of periods, a probability distribution of the constraint condition for each of a plurality of requested arrangements each of which indicates requested quantities of the product for each of the plurality of periods, and output at least one of the plurality of requested arrangements, based on the generated probability distribution and the received condition regarding the constraint condition.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system configuration;

FIG. 2 is a diagram illustrating an entire configuration of an order quantity determination device;

FIG. 3 is a diagram illustrating an example of an order prediction screen;

FIG. 4 is a graph illustrating an example of a demand prediction result;

FIG. 5 is a diagram schematically illustrating predicted demand quantity and occurrence probability for each prediction period, which are stored in demand prediction information;

FIG. 6 is a diagram illustrating an example of an occurrence probability when demands of prediction periods are combined;

FIG. 7 is a graph illustrating an example of a correspondence relationship between a profit and an accumulated occurrence probability;

FIG. 8 is a graph illustrating a method for obtaining a profit that is ensured;

FIG. 9 is a graph illustrating a method for obtaining a probability that a profit is ensured;

FIG. 10 is a graph illustrating a method for obtaining a probability with which a designated profit is able to be ensured and a profit that is ensured with a designated probability;

FIG. 11 is a graph illustrating a method for obtaining a probability with which a designated profit is able to be ensured and a probability that a designated profit is ensured;

FIG. 12 is a flow chart illustrating an example of procedures of order quantity determination processing; and

FIG. 13 is a diagram illustrating a computer that executes an order quantity determination program.

### DESCRIPTION OF EMBODIMENTS

The above-described known technique is used for outputting an order quantity plan for reducing the probability of out-of-stock occurrence to a predetermined value or lower and. However, according to the known technique, it is not possible to provide a system to output various order quantity plans in accordance with a condition designated by an ordering person.

One aspect of the embodiments is to provide a recording medium storing therein an order quantity determination program, an order quantity determination method, and an order quantity determination system which allow output of an order quantity plan in accordance with a condition designated by an ordering person. Hereinafter, the word “order quantities” may also be referred to as “requested quantities”.

Embodiments will be described below with reference to the accompanying drawings.

### First Embodiment

### System Configuration

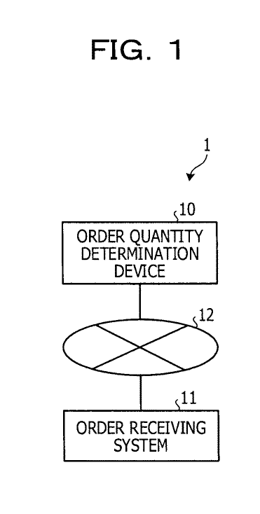

First, an example of a system that performs ordering using an order quantity determination device according to a first embodiment will be described. FIG. 1 is a diagram illustrating an example of a system configuration. As illustrated in FIG. 1, a system 1 includes an order quantity determination device 10 and an order receiving system 11. The order quantity determination device 10 and the order receiving system 11 are coupled to each other so as to be communicable via a network 12, and are enabled to exchange various types of information. As an example of the network 12, whether wired or wireless, a mobile communication, such as a mobile phone and the like, or an arbitrary type of communication network, such as the Internet, a local area network (LAN), a virtual private network (VPN), and the like, may be employed.

The order receiving system 11 is a system used for managing ordering and inventory of products. For example, the order receiving system 11 is a system that operates on one or more server computers. The order receiving system 11 stores master data in which sales price, cost, and the like of a product are set. The order receiving system 11 is configured such that product sales information and product delivery information are uploaded from a point of sale (POS) system of a store and the like. The order receiving system 11 manages a current product inventory quantity, based on the uploaded product sales information and product delivery information. Also, the order receiving system 11 performs processing regarding product ordering. For example, the order receiving system 11 receives ordering data indicating the order quantity for each product and transmits the ordering data to a party that handles the product.

The order quantity determination device 10 is a device that determines a product order quantity. The order quantity determination device 10 obtains an optimal order quantity of a product that is an order target for a predetermined order period and outputs an order plan for the order period. Hereinafter, the word “order plan” may also be referred as “requested arrangement”. In this embodiment, a case where a period for an order target is three days, that is, today, tomorrow, and the day after tomorrow, and the order quantity determination device 10 outputs an order plan indicating three order quantities, that is, an order quantity for each of the three days, will be described. The order quantity determination device 10 is a computer, such as, for example, a personal computer, a server computer, and the like. The order quantity determination device 10 may be implemented as a single computer, and also, may be implemented by a plurality of computers. Note that, in this embodiment, an example where the order quantity determination device 10 is a single computer will be described.

[Configuration of Order Quantity Determination Device]

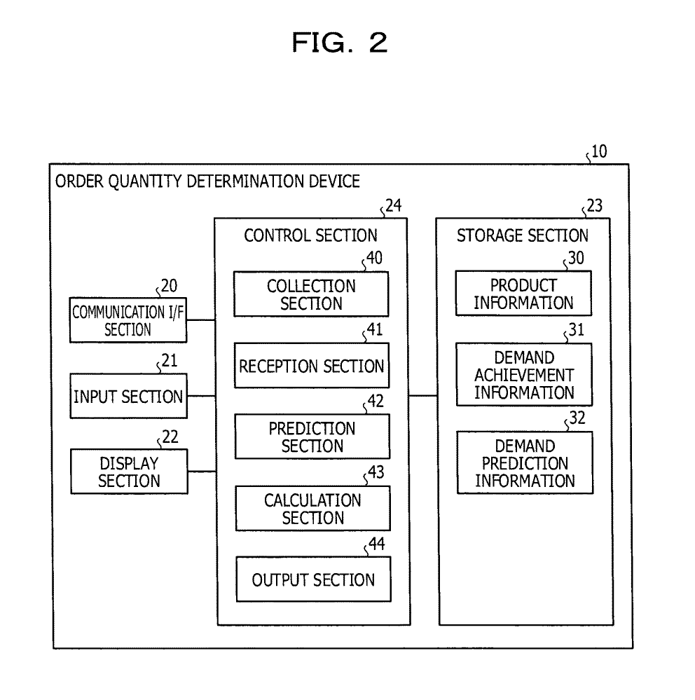

The order quantity determination device 10 according to the first embodiment will be described. FIG. 2 is a diagram illustrating an entire configuration of an order quantity determination device. As illustrated in an example of FIG. 2, the order quantity determination device 10 includes a communication interface (I/F) section 20, an input section 21, a display section 22, a storage section 23, and a control section 24. Note that the order quantity determination device 10 may include an equipment other than those described above.

The communication I/F section 20 is an interface that performs communication control between the order quantity determination device 10 and another device. As the communication I/F section 20, a network interface card, such as a LAN card and the like, may be employed.

The communication I/F section 20 transmits and receives various types of information to and from another device via the network 12. For example, the communication I/F section 20 is configured to be capable of transmitting and receiving various types of information to and from the order receiving system 11, and transmits and receives various types of information regarding a product that is an order target to and from the order receiving system 11.

The input section 21 is an input device that inputs various types of information. As the input section 21, an input device that receives an input of an operation of a mouse, a keyboard, or the like, may be used. The input section 21 receives input of various types of information. For example, the input section 21 receives inputs of various operations regarding order quantity determination. The input section 21 receives an operation input from a user and inputs operation information indicating received operation contents to the control section 24.

The display section 22 is a display device that displays various types of information. As the display section 22, a display device, such as a liquid crystal display (LCD), a cathode ray tube (CRT), and the like, may be used. The display section 22 displays various types of information. For example, the display section 22 displays various screens, such as a screen on which various conditions regarding ordering and a determined order quantity are displayed, and the like. For example, the display section 22 displays an order prediction screen that will be described later.

The storage section 23 is a storage device, such as a hard disk, a solid state drive (SSD), an optical disk, and the like. Note that the storage section 23 may be a data-rewritable semiconductor memory, such as a random access memory (RAM), a flash memory, a non-volatile static random access memory (NVSRAM), and the like.

The storage section 23 stores an operating system (OS) and various programs that are executed by the control section 24. For example, the storage section 23 stores various programs used for determining an order quantity. Furthermore, the storage section 23 stores various types of data used for a program executed by the control section 24. For example, the storage section 23 stores product information 30, demand achievement information 31, and demand prediction information 32. Hereinafter, the word “demand prediction” may also be referred to as “estimated requirement”.

The product information 30 is data that stores various types of information regarding the product that is an order target. The product information 30 stores various types of information, such as a current inventory quantity of the product that is an order target, a profit per product sold, and the like, used for determining an order quantity.

The demand achievement information 31 is data that stores information regarding past demands regarding the product that is an order target. For example, the demand achievement information 31 stores past demand quantities of the product that is an order target.

The demand prediction information 32 is data that stores information regarding a predicted demand regarding the product that is an order target. For example, the demand prediction information 32 stores, for each predicted demand quantity of the product, an occurrence probability that a demand of the demand quantity occurs.

The control section 24 is a device that controls the order quantity determination device 10. As the control section 24, an electronic circuit, such as a central processing unit (CPU), a micro processing unit (MPU), and the like, or an integrated circuit, such as an application specific integrated circuit (ASIC), a field programmable gate array (FPGA), and the like, may be employed. The control section 24 includes an internal memory used for storing a program in which various processing procedures are defined and control data, and executes various types of processing using the program and the control data. The various programs are operated, and thus, the control section 24 functions as various processing units. For example, the control section 24 includes a collection section 40, a reception section 41, a prediction section 42, a calculation section 43, and an output section 44.

The collection section 40 performs various collections. For example, the collection section 40 collects various types of information regarding the product that is an order target. For example, the collection section 40 collects sales price, cost, and current inventory quantity of a product that is an order target from the order receiving system 11. The collection section 40 subtracts the cost from the sales price of the product that is an order target and obtains a profit per product sold for the product that is an order target. The collection section 40 causes the product information 30 to store the current inventory quantity of the product that is an order target and the profit per product. Also, the collection section 40 collects past demand quantities for the product that is an order target from the order receiving system 11, and causes the demand achievement information 31 to store the past demand quantities for the product that is an order target. Note that, in this embodiment, the collection section 40 collects information from the order receiving system 11 and thus the product information 30 and the demand achievement information 31 store the information, but the present disclosure is not limited thereto. For the product information 30 and the demand achievement information 31, information may be stored by another system or an administrator.

The reception section 41 performs reception of various conditions regarding ordering. For example, the reception section 41 receives, as the various conditions regarding ordering, conditions regarding profits. For example, the reception section 41 causes an order prediction screen, which will be described later, to be displayed and receives inputs of the conditions regarding profits from the order prediction screen. Also, for example, the reception section 41 receives, as the various conditions regarding ordering, various constraint conditions in obtaining an order quantity. For example, the reception section 41 receives inputs of the constraint conditions from the order prediction screen.

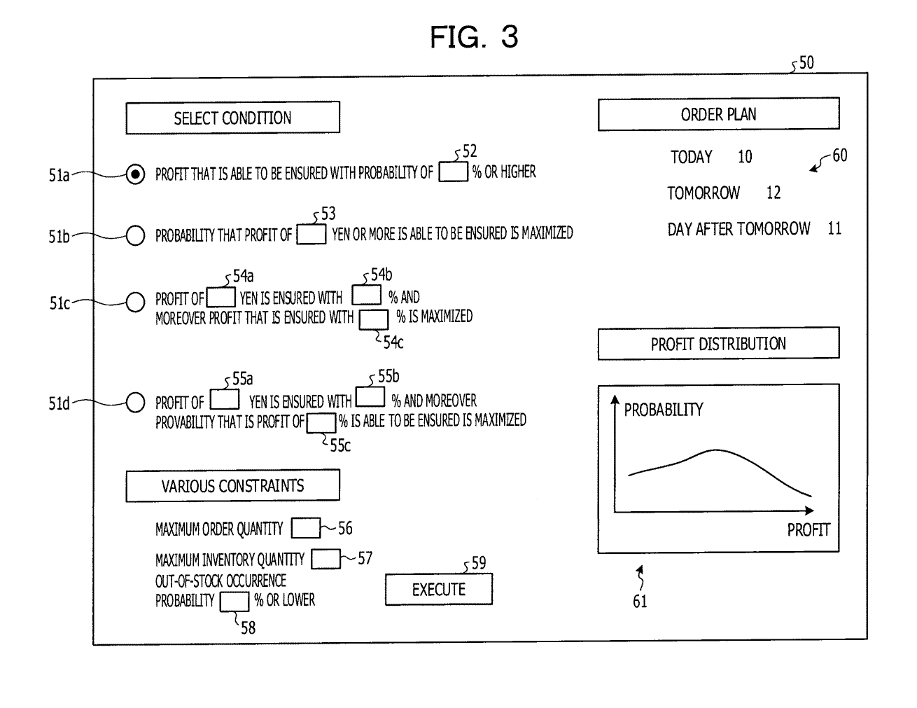

FIG. 3 is a diagram illustrating an example of an order prediction screen. An order prediction screen 50 is configured such that a condition may be selected from a plurality of modes for ordering, and radio buttons 51a, 51b, 51c, and 51d used for selecting a mode are provided therein. The radio button 51a is a button used for designating a first order mode in which an order quantity that maximizes a profit that may be ensured with a designated probability or higher is obtained. The radio button 51b is a button used for designating a second order mode in which an order quantity that maximizes a probability that a designated profit or a higher profit is able to be ensured is obtained. The radio button 51c is a button used for designating a third order mode in which an order quantity that ensures a profit designated with a designated probability and also maximizes a profit that is able to be ensured with the designated probability or a higher probability is obtained. The radio button 51d is a button used for designating a fourth order mode in which an order quantity that ensures a profit designated with a designated probability and also maximizes a probability that the designated profit or a higher profit is able to be ensured is obtained.

Input areas in which conditions regarding profits in each mode are designated are provided in the order prediction screen 50. For example, an input area 52 in which a probability with which a profit that is ensured is maximized is designated as a condition regarding a profit in the first order mode is provided in the order prediction screen 50. Also, an input area 53 in which a profit that is desired to be ensured is designated as a condition regarding a profit in the second order mode is provided in the order prediction screen 50. Also, an input area 54a in which a profit that is to be ensured is designated as conditions regarding profits in the third order mode, an input area 54b in which a probability with which a profit is to be ensured is designated as a condition regarding a profit in the third order mode, an input area 54c in which a probability with which a profit is maximized is designated as a condition regarding a profit in the third order mode are provided in the order prediction screen 50. Also, an input area 55a in which a profit that is to be ensured is designated as a condition regarding a profit in the fourth order mode, an input area 55b in which a probability with which a profit is to be ensured is designated as a condition regarding a profit in the fourth order mode, and an input area 55c in which a profit that is desired to be ensured is designated as a condition regarding a profit in the fourth order mode are provided in the order prediction screen 50.

Also, input areas in which various constraint conditions in obtaining an order quantity are designated are provided in the order prediction screen 50. For example, an input area 56 in which a maximum order quantity at each order timing is designated as a constraint condition, and an input area 57 in which a maximum inventory quantity is designated as a constraint condition are provided in the order prediction screen 50. Also, an input area 58 in which a probability of out-of-stock occurrence, that is, a probability that the product is sold out, is designated as a constraint condition is provided in the order prediction screen 50.

Also, an execution button 59 is provided in the order prediction screen 50. An ordering person selects an order mode via the order prediction screen 50, designates conditions regarding profits in accordance with the selected order mode, designates constraint conditions, and then, designates the execution button 59. Thus, the order quantity determination device 10 calculates an optimal product order quantity and determines an optimal order plan.

An order quantity display area 60 in which an order quantity of a determined order plan for an order target period is displayed is provided in the order prediction screen 50. In this embodiment, the order target period is set to be today, tomorrow, and the day after tomorrow, and, as an order plan, three order quantities, that is, an order quantity for each of the three days, are determined. In an example of FIG. 3, three order quantities for today, tomorrow, and the day after tomorrow are displayed in the order quantity display area 60. Also, a probability distribution display area 61 in which a profit probability distribution in a determined order plan is displayed is provided in the order prediction screen 50. Hereinafter, the word “profit probability distribution” may also be referred to as “probability distribution of the constraint condition”.

Returning to FIG. 2, the prediction section 42 performs various predictions. For example, the prediction section 42 predicts a demand in an order target period, based on a history of past demands for the product that is an order target stored in the demand achievement information 31. For example, the prediction section 42 performs a time-series analysis in accordance with autoregressive integrated moving average (ARIMA) model or the like to predict a demand for the product that is an order target. Note that a demand prediction method is not limited thereto, any method may be used. For example, past demands may be learned by a support vector machine, or the like, to predict a demand quantity.

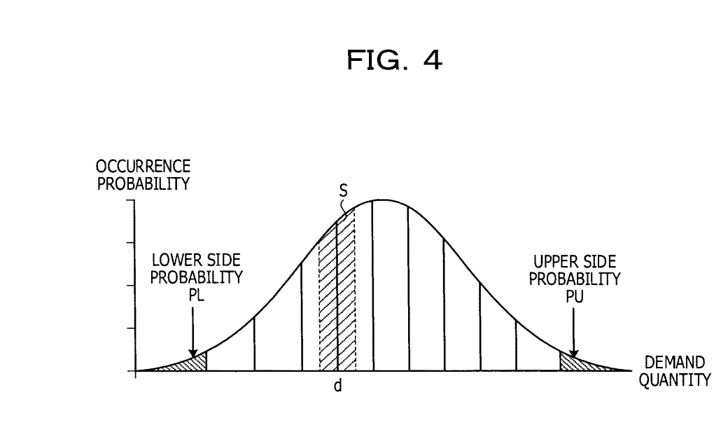

FIG. 4 is a graph illustrating an example of a demand prediction result. A demand prediction result is obtained as an occurrence probability relative to each demand quantity. In FIG. 4, a graph of the occurrence probability relative to each demand quantity is illustrated. The abscissa axis of the graph of FIG. 4 indicates a demand quantity for a product. The ordinate axis of the graph of FIG. 4 indicates an occurrence probability for the demand quantity. In an example of FIG. 4, the probability distribution for demands for the product is a normal distribution. The demand quantity for a product that individually sold is represented by an integer. Therefore, when a graph is represented in a continuous distribution model, the prediction section 42 performs discretization, obtains a probability that a demand occurs for each demand quantity represented by an integer, and causes the demand prediction information 32 to store the probability. For example, as illustrated in FIG. 4, the prediction section 42 causes the demand prediction information 32 to store, as an occurrence probability that a demand of a demand quantity d occurs, a probability corresponding to an area S of a probability distribution in a zone from a point 0.5 before the demand quantity d to a point 0.5 after the demand quantity d. Note that the prediction section 42 may drop, in the demand probability distribution, a part other than a predetermined significant probability zone. For example, as illustrated in FIG. 4, the prediction section 42 may drop a part other than a zone in which an upper side probability Pᵤ+a lower side probability P_{L} is 1−a significant probability, and cause the demand prediction information 32 to store the occurrence probability for each demand quantity in the zone. The significant probability may be an externally settable. For example, an input area in which the significant probability is designated may be provided in the order prediction screen 50 so that an ordering person may set the significant probability.

For an order target period of a product that is an order target, assuming that a demand of each of demand quantities, which have been predicted in prediction periods up to a prediction period immediately before a current prediction period, has occurred, the prediction section 42 performs case classification and predicts a demand quantity sequentially for each prediction period. In this embodiment, a demand is predicted for three prediction periods, that is, prediction periods for today, tomorrow, and the day after tomorrow. The prediction section 42 causes the demand prediction information 32 to store, for each demand quantity predicted in each case, an occurrence probability of the demand of the demand quantity.

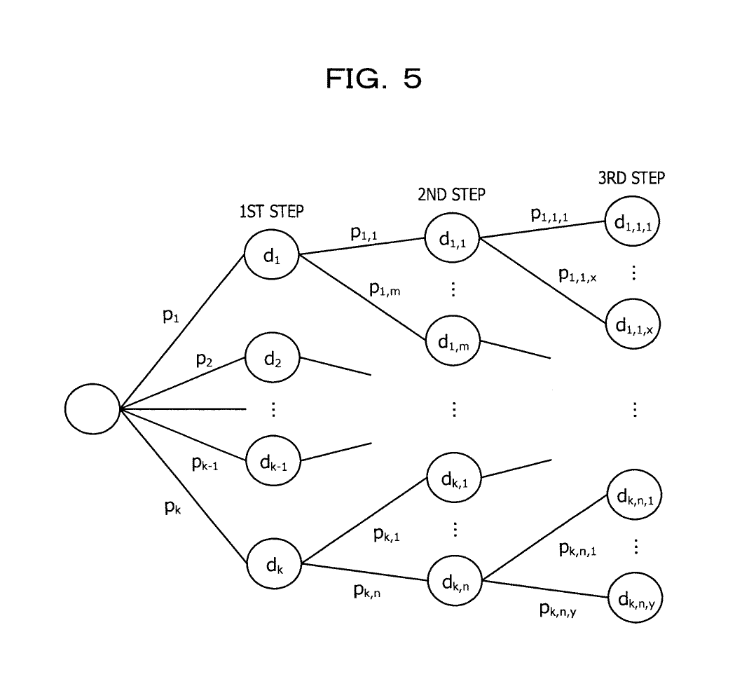

FIG. 5 is a diagram schematically illustrating predicted demand quantity and occurrence probability for each prediction period, which are stored in demand prediction information. For a prediction period of a first step, predicted demand quantities and occurrence probabilities are stored. In an example of FIG. 5, demand quantities d₁ to dₖ and occurrence probabilities p₁ to pₖ of the prediction period of the first step are stored. For a prediction period of a second step, demand quantities that have been predicted after performing case classification on each of the demand quantities of the prediction period of the first step and occurrence probabilities are stored. For example, demand quantities d_{1,1} to d_{1,m}, which have been predicted as the demand quantity d₁ of the prediction period of the first step, and occurrence probabilities p_{1,1} to p_{1,m} are stored. For a prediction period of a third step, demand quantities that have been predicted after performing case classification on each of the demand quantities of the first and second steps and occurrence probability are stored. For example, demand quantities d_{1,1,1} to d_{1,1,x} and occurrence probabilities p_{1,1,1} to P_{1,1,x} that have been predicted, assuming that the demand quantity of the prediction period of the first step is the demand quantity d₁ and the demand quantity of the prediction period of the second step is d_{1,1}, are stored. Note that, in this embodiment, a case where the prediction section 42 predicts a demand in a prediction period, based on past demand quantities of a product, has been described, but the present disclosure is not limited thereto. The demand prediction information 32 may store a prediction result obtained in a different system, and also, the administrator may set the demand prediction information 32. Also, the prediction section 42 may cause the demand prediction information 32 to store, as a prediction result, past demand quantities, such as a demand quantity in an immediately previous period, which is the same as a period of an order target, a demand quantity in the same period in the past, and the like, as they are, or after correcting them.

The calculation section 43 performs various calculations. For example, the calculation section 43 calculates a profit probability distribution for each of a plurality of order plans that indicate order quantities of a product in a plurality of periods, based on demand prediction for the product, which is stored in the demand prediction information 32. For example, the calculation section 43 sets, as an initial order plan, an order quantity that satisfies a constraint condition for each prediction period in an order target period. For example, if a maximum order quantity is designated, the calculation section 43 randomly sets an order quantity to a value equal to or smaller than the maximum order quantity for each prediction period. Note that a method for setting an initial order plan is not limited thereto. An initial order plan may be fixedly set in advance and may be set by an ordering person, and a past order plan, such as an order plan ordering of which was performed immediately previously or an order plan ordering of which was performed at the same time in the past may be used as an initial order plan. In this case, past order plans are collected from the order receiving system 11 by the collection section 40.

Based on demand prediction for a product stored in the demand prediction information 32, the calculation section 43 combines demands for the product in prediction periods, multiplies occurrence probabilities of the demands in prediction periods, which have been combined, and thus, obtains an occurrence probability for each combination of the demands in the prediction periods.

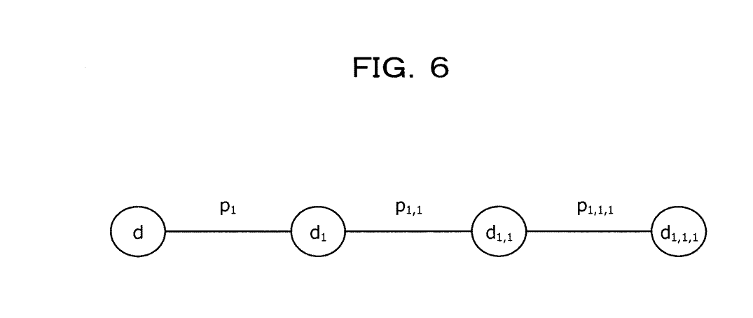

FIG. 6 is a diagram illustrating an example of an occurrence probability when demands of prediction periods are combined. For example, FIG. 6 illustrates a pathway in which the demand quantity d₁ in the prediction period of the first step, the demand quantity d_{1,1} in the prediction period of the second step, and the demand quantity d_{1,1,1} in the prediction period of the third step are combined. In this case, the calculation section 43 multiplies the occurrence probability p₁, the occurrence probability p_{1,1}, and the occurrence probability p_{1,1,1}, and thus, obtains an occurrence probability for the pathway of the demand quantities d_{1,1,1}, and d_{1,1,1}.

The calculation section 43 calculates a profit when ordering of an order plan is performed for each pathway in which demands of prediction periods are combined. For example, if a product ordered in a previous prediction period is delivered in a next prediction period, an inventory quantity y[k+1] of a prediction period k+1 is obtained, based on Expression 1 below.

y[k+1]=y[k]+u[k]−D[k] [Expression 1]

In Expression 1, y[k] is an inventory quantity of a prediction period k.

In Expression 1, u[k] is an order quantity of the prediction period k.

In Expression 1, D[k] is a demand quantity of the prediction period k.

For example, an inventory quantity of tomorrow is a value obtained by adding an order quantity to a current inventory quantity and subtracting a demand quantity of today from a value obtained by the addition. The calculation section 43 sequentially calculates respective inventory quantities of prediction periods using Expression 1.

Incidentally, assuming that the demand quantity D[k] is subtracted from an inventory quantity for a product, if the demand D[k] is greater than the inventory quantity, the inventory quantity might be negative. However, when the inventory quantity of the product reaches zero, an out-of-stock situation occurs and there is no product to sell, so that the product inventory quantity does not become smaller than zero.

Thus, the calculation section 43 corrects the inventory quantity in the prediction period k+1, using Expression 2 below. A corrected inventory quantity in the prediction period k+1 is denoted by yp[k+1].

yp[k+1]=max(y[k+1],0) [Expression 2]

In Expression 2, if the inventory quantity y[k+1] in the prediction period k+1 is zero or smaller, the corrected inventory quantity yp[k+1] in the prediction period k+1 is zero.

If, in order to simplify profit calculation, a sales quantity of a product in each prediction period is limited to only an inventory quantity, the sales quantity V[k+1] in the prediction period [k+1] is obtained, based on Expression 3 below.

V[k+1]=min(yp[k+1],D[k+1]) [Expression 3]

In Expression 3, one of the inventory quantity yp[k+1] and the demand quantity D[k+1] which is smaller is the sales quantity V[k+1].

If a profit per product sold is denoted by m, a profit p[k+1] in the prediction period k+1 is obtained, based on Expression 4 below.

p[k+1]=m×V[k+1] [Expression 4]

Note that a profit calculation method is not limited to the above-described method, but various methods may be used. For example, a profit may be calculated in consideration of various costs, such as an inventory holding cost, an ordering cost, and the like. Also, an inventory quantity may be calculated in consideration of a lead time, and the like.

The calculation section 43 adds up profits in prediction periods where ordering of an order plan was performed for each pathway in which demands are combined, and calculates a profit for each of all pathways. The calculation section 43 compares the profits of all pathways to one another, adds up occurrence probabilities of a pathway for pathways profits for which the same profit is obtained, and thus, obtains the correspondence of a profit and an occurrence probability of the profit. The calculation section 43 sorts respective occurrence probabilities of profits in the order of the profits, and calculates a profit probability distribution in which a profit and an occurrence probability of the profit are associated with one another in the order of the profits.

The output section 44 performs various outputs. For example, the output section 44 outputs one of order plans, based on a calculated profit probability distribution and a received condition regarding a profit. For example, for each profit in the profit probability distribution, the output section 44 adds up occurrence probabilities of profits equal to or lower than the profit, and obtains a correspondence relationship between the profit and an accumulated occurrence probability of the profits equal to or lower than the profit.

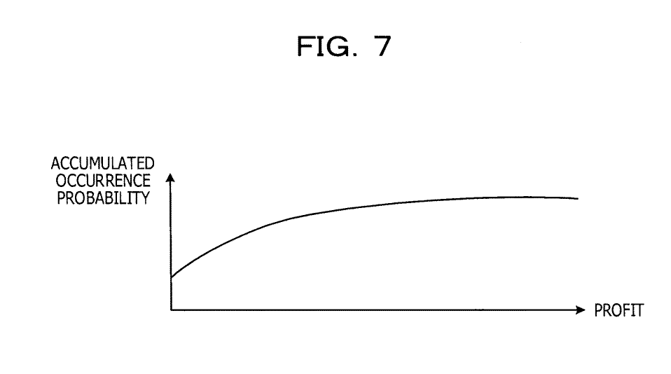

FIG. 7 is a graph illustrating an example of a correspondence relationship between a profit and an accumulated occurrence probability. FIG. 7 illustrates a graph of a correspondence relationship between a profit and an accumulated occurrence probability. The abscissa axis of the graph of FIG. 7 indicates the profit. The ordinate axis of the graph of FIG. 7 indicates the accumulated occurrence probability. The graph illustrates a correspondence relationship between a profit and a probability that the profit is ensured.

The output section 44 determines, for each order plan, whether or not the order plan satisfies a condition regarding a profit, using a correspondence relationship between a profit in the order plan and an accumulated occurrence probability of profits equal to or lower than the profit.

For example, if the first order mode is designated, the output section 44 obtains, for an order plan, a profit that is ensured with a designated probability from the correspondence relationship between a profit in the order plan and a probability that the profit is ensured.

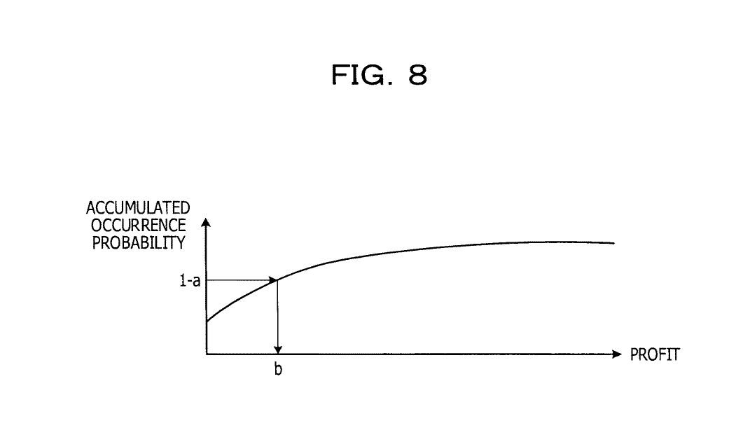

FIG. 8 is a graph illustrating a method for obtaining a profit that is ensured. FIG. 8 illustrates the graph of a correspondence relationship between a profit and an accumulated occurrence probability illustrated in FIG. 7. For example, assume that the radio button 51a is selected in the order prediction screen 50 illustrated in FIG. 3 and a probability a is designated in the input area 52. In this case, the output section 44 obtains a profit b at which the accumulated occurrence probability corresponds to 1−a in the graph illustrated in FIG. 8. In this embodiment, a graph of the correspondence relationship between a profit and an accumulated occurrence probability is obtained by adding up, for a profit, occurrence probabilities of profits equal to or lower than the profit. Therefore, in the graph, the maximum value of the accumulated occurrence probabilities is 1, and a profit b corresponding to a difference 1−a from 1 represents a profit that is ensured with the probability a.

For example, if the second order mode is designated, the output section 44 obtains, for an order plan, a probability that a designated profit is ensured from the correspondence relationship between a profit in the order plan and a probability that the profit is ensured.

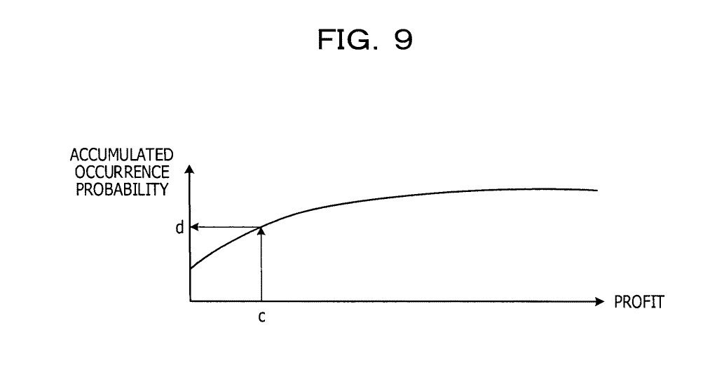

FIG. 9 is a graph illustrating a method for obtaining a probability that a profit is ensured. FIG. 9 illustrates the graph of a correspondence relationship between a profit and an accumulated occurrence probability illustrated in FIG. 7. For example, assume that the radio button 51b is selected in the order prediction screen 50 illustrated in FIG. 3 and a profit c is designated in the input area 53. In this case, the output section 44 obtains an accumulated occurrence probability d corresponding to the profit c in the graph illustrated in FIG. 9. A graph of the correspondence relationship between a profit and an accumulated occurrence probability is herein obtained by adding up, for a profit, probabilities of profits equal to or lower than the profit. Therefore, as the occurrence probability d reduces, the probability that the profit c is ensured increases.

For example, if the third order mode is designated, the output section 44 obtains, for an order plan, a probability with which a designated profit is able to be ensured and a profit that is ensured with a designated probability from the correspondence relationship of a profit in the order plan and a probability that the profit is ensured.

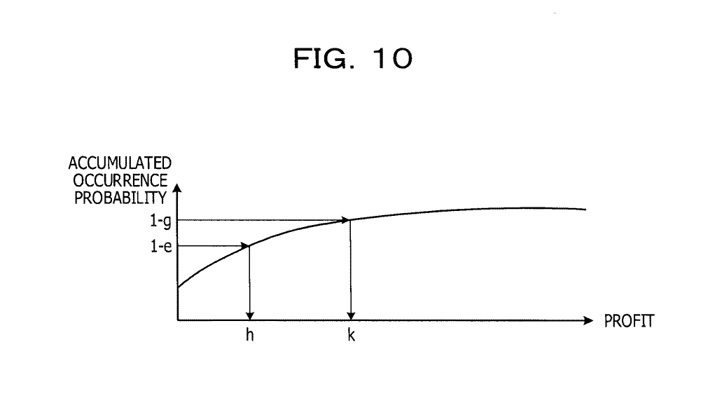

FIG. 10 is a graph illustrating a method for obtaining a probability with which a designated profit is able to be ensured and a profit that is ensured with a designated probability. FIG. 10 illustrates the graph of a correspondence relationship between a profit and an accumulated occurrence probability illustrated in FIG. 7. For example, assume that the radio button 51c is selected in the order prediction screen 50 illustrated in FIG. 3, a profit f is designated in the input area 54a, a probability e is designated in the input area 54b, and a probability g is designated in the input area 54c. In this case, the output section 44 obtains a profit h at which the accumulated occurrence probability corresponds to 1−e in the graph of FIG. 10. If the profit h is greater than the profit f, the profit f or a higher profit is able to be ensured with the probability e. The output section 44 obtains a profit k at which the accumulated occurrence probability corresponds to 1−g in the graph illustrated in FIG. 10. The profit k is a profit that is ensured with the probability g.

For example, if the fourth order mode is designated, the output section 44 obtains, for an order plan, a probability with which a designated profit is able to be ensured and a probability that a designated profit is ensured from the correspondence relationship between a profit in the order plan and a probability that the profit is ensured.

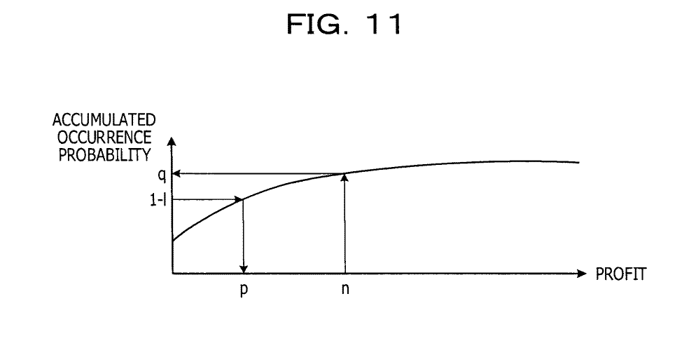

FIG. 11 is a graph illustrating a method for obtaining a probability with which a designated profit is able to be ensured and a probability that a designated profit is ensured. FIG. 11 illustrates the graph of a correspondence relationship between a profit and an accumulated occurrence probability illustrated in FIG. 7. For example, assume that the radio button 51d is selected in the order prediction screen 50 illustrated in FIG. 3, a profit m is designated in the input area 55a, a probability l is designated in the input area 55b, and a profit n is designated in the input area 55c. In this case, the output section 44 obtains a profit p at which the accumulated probability corresponds to 1−l. If the profit p is greater than the profit m, the profit m or a higher profit is able to be ensured with the probability l. Also, the output section 44 obtains an accumulated occurrence probability q corresponding to the profit n in the graph illustrated in FIG. 11. As the occurrence probability q reduces, a probability that the profit n is ensured increases.

The output section 44 changes an order plan and repeats causing the calculation section 43 to calculate a profit probability distribution. The output section 44 determines, for each order plan, whether or not a designated constraint condition is satisfied. For example, if a maximum order quantity is designated as a constraint condition in the input area 56 in the order prediction screen 50 illustrated in FIG. 3, the output section 44 determines whether or not an order quantity of each prediction period in the order plan is the maximum order quantity or less. If a maximum inventory quantity is designated as a constraint condition in the input area 57 in the order prediction screen 50 illustrated in FIG. 3, the output section 44 determines whether or not an inventory quantity in each prediction period of the order plan is the maximum inventory quantity or less. If a probability of out-of-stock occurrence is designated as a constraint condition in the input area 58 in the order prediction screen 50 illustrated in FIG. 3, the output section 44 calculates the probability of out-of-stock occurrence in the order plan and determines whether or not the probability of out-of-stock occurrence in the order plan is a designated probability of out-of-stock occurrence. The probability of out-of-stock occurrence is calculated in the following manner. For example, if ordering of the order plan is performed, the output section 44 determines, for each pathway in which demands in prediction periods are combined, which is illustrated in FIG. 6, whether or not an out-of-stock situation in which an inventory is negative occurs, and calculates the probability of out-of-stock occurrence from the ratio of the number of pathways in which an out-of-stock situation has occurred to the number of all pathways.

The output section 44 obtains a correspondence relationship between a profit in a changed order plan and an accumulated occurrence probability of profits equal to or lower than the profit from a calculated profit probability distribution of an order plan that satisfies a constraint condition, and determines whether or not a condition regarding a profit in accordance with a designated order mode is satisfied. If there is any order plan that satisfies the condition regarding a profit, the output section 44 outputs an order plan, among the order plans that satisfy the condition regarding a profit, in which a probability that the profit is ensured is the highest. For example, the output section 44 sets a designated constraint condition using an optimal algorithm, optimizes an order quantity in each prediction period of an order plan, and thereby, calculates an optimal order plan in accordance with the designated order mode. As the optimal algorithm, genetic algorithm (GA), particle swarm optimization (PSO), or the like, may be used. Thus, in the first order mode, as illustrated in FIG. 8, if the probability a with which an ensured profit is maximized is designated, an order plan in which the profit b at which the accumulated occurrence probability is 1−a is greater is obtained as an optimal order plan. In the second order mode, as illustrated in FIG. 9, if the profit that is desired to be ensured is designated, an order plan in which the occurrence probability d at the profit c is smaller is obtained as an optimal order plan. In the third order mode, as illustrated in FIG. 10, if the profit f that is to be ensured, the probability e with which the profit is to be ensured, and the probability g with which the profit is maximized are designated, an order plan in which the profit h at the accumulated occurrence probability 1−e is greater than the profit f and the profit k at the accumulated occurrence probability 1−g is greater is obtained as an optimal order plan. In the fourth order mode, as illustrated in FIG. 11, if the profit m that is to be ensured, the probability l with which the profit is to be ensured, and the profit n that is desired to be ensured are designated, an order plan in which the profit p at the accumulated occurrence probability 1−l is greater than the profit m and the occurrence probability q at the profit n is smaller is obtained as an optimal order plan.

If an optimal order plan that satisfies a condition regarding a profit is calculated, the output section 44 outputs the calculated optimal order plan. For example, the output section 44 outputs an order quantity in each prediction period of the optimal order plan to the order quantity display area 60 of the order prediction screen 50. In this embodiment, as illustrated in FIG. 3, the output section 44 causes the order quantity display area 60 to display three order quantities of today, tomorrow, and the day after tomorrow. Also, as illustrated in FIG. 3, the output section 44 causes the profit probability distribution in the output optimal order plan to be displayed in the probability distribution display area 61.

If there is not any order plan that satisfies the condition regarding a profit, the output section 44 outputs an error indicating that there is not any order plan that satisfies the condition. Note that the output section 44 may output order data of the calculated optimal order plan to the order receiving system 11 and thus perform automatic ordering.

[Flow of Processing]

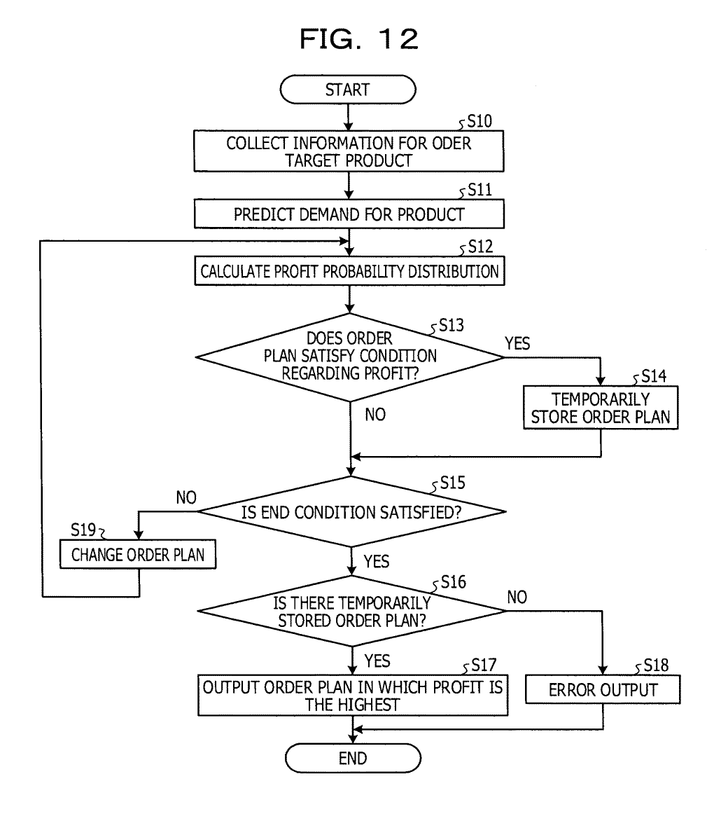

Next, a flow of order quantity determination processing in which the order quantity determination device 10 determines an order quantity will be described. FIG. 12 is a flow chart illustrating an example of procedures of order quantity determination processing. The order quantity determination processing is executed at a predetermined timing, that is, for example, a timing at which a condition is designated in the order prediction screen 50 and the execution button 59 is selected.

As illustrated in FIG. 12, the collection section 40 collects various types of information regarding a product that is an order target and stores the various types of information in the storage section 23 (510). For example, the collection section 40 collects sales price, cost, and current inventory quantity of the product that is an order target from the order receiving system 11 and stores the collected current inventory quantity, and a profit per product sold, obtained by subtracting the cost from the sales price, in the product information 30. Also, the collection section 40 collects past demand quantities of the product that is an order target from the order receiving system 11 and stores the past demand quantities of the product that is an order target in the demand achievement information 31.

The prediction section 42 predicts a demand for the product that is an order target for each prediction period of an order target period, and stores, for each predicted demand quantity, an occurrence probability of a demand of the demand quantity in the demand prediction information 32 (S11).

The calculation section 43 calculates an occurrence probability for each pathway in which demands for the product in prediction periods are combined, based on demand prediction for the product stored in the demand prediction information 32, and calculates a profit probability distribution when ordering of an order plan is performed (S12). As the order plan, in initial processing, an initial order plan is used, and subsequently, a changed order plan is used.

The output section 44 obtains a correspondence relationship between a profit and a probability that the profit is ensured from the profit probability distribution, and determines, using the correspondence relationship, whether or not an order plan satisfies a condition regarding a profit (S13). If the order plan satisfies the condition regarding a profit (YES in S13), the output section 44 temporarily stores the order plan as an candidate of an optimal order plan (S14), and the process proceeds to S15, which will be described later. On the other hand, if the order plan does not satisfy the condition regarding a profit (NO in S13), the process proceeds to S15, which will be described later.

The output section 44 determines whether or not a predetermined end condition is satisfied (S15). For example, the output section 44 determines whether or not an end condition of the optimal algorithm, such as GA, PSO, and the like, is satisfied. The end condition may be the number of order plan changes that have been performed. Also, the end condition may be that, as a result of increasing and reducing each of order quantities of prediction periods to a value around an order quantity of an order plan, a profit is reduced in each of the prediction periods. Also, the end condition may be a combination of a plurality of conditions. If the end condition is satisfied (YES in S15), the output section 44 determines whether or not there is any temporarily stored order plan (S16). If there is any temporarily stored order plans (YES in S16), the output section 44 outputs an order plan, among temporarily stored order plans, in which an ensured profit is the highest (S17), and ends processing.

On the other hand, if there is not any temporarily stored order plan (NO in S16), the output section 44 outputs an error indicating that there is not any order plan that satisfies the condition (S18), and ends processing.

If the end condition is not satisfied (NO in S15), the output section 44 changes the order plan (S19). For example, the output section 44 changes the order quantity of the order plan in accordance with the optimal algorithm. Thereafter, the process proceeds to S12 described above to calculate a profit probability distribution in a changed order plan.

[Advantages]

As has been described above, the order quantity determination device 10 according to this embodiment receives a condition regarding a profit. The order quantity determination device 10 calculates, based on demand prediction for a product, a profit probability distribution for each of a plurality of order plans that indicate order quantities of the product in a plurality of periods. The order quantity determination device 10 outputs, based on the calculated profit probability distribution and the received condition regarding a profit, one of the order plans. As described above, the order quantity determination device 10 receives a condition regarding a profit, and thus, an ordering person may designate a condition regarding a profit in accordance with an ordering strategy. The order quantity determination device 10 outputs an output plan in accordance with a received condition regarding a profit. Thus, the order quantity determination device 10 may output an order quantity plan in accordance with a condition designated by the ordering person.

Also, the order quantity determination device 10 according to this embodiment combines demands for a product, which are predicted for each of a plurality of periods. The order quantity determination device 10 multiples occurrence probabilities of the demands in the plurality of periods, which have been combined, and thus obtains an occurrence probability for each combination of the demands in the plurality of periods. The order quantity determination device 10 calculates, for each order plan, a profit probability distribution from a profit in the combination of the demands and an occurrence probability of the combination of the demands. The order quantity determination device 10 obtains, for each order plan, a correspondence relationship between a profit and a probability that the profit is ensured from a profit probability distribution. The order quantity determination device 10 outputs an order plan that satisfies a condition regarding a profit in the correspondence relationship. As described above, the order quantity determination device 10 calculates a profit probability distribution, obtains a correspondence relationship between a profit and a probability that the profit is ensured from the profit probability distribution, and thereby may obtain an order plan that satisfies the condition regarding a profit with a higher probability.

Also, the order quantity determination device 10 according to this embodiment receives, as a condition regarding a profit, designation of a probability with which a profit that is ensured is maximized. The order quantity determination device 10 obtains, for each order plan, a profit that is ensured with the designated probability and outputs an order plan in which an ensured profit is the highest. Thus, the order quantity determination device 10 may obtain an order plan in which a profit that is ensured with a probability designated by an ordering person is the highest.

Also, the order quantity determination device 10 according to this embodiment receives, as a condition regarding a profit, designation of a profit that is desired to be ensured. The order quantity determination device 10 obtains, for each order plan, a probability that the designated profit is ensured and outputs an order plan in which a probability that the designated profit is ensured is the highest. Thus, the order quantity determination device 10 may obtain an order plan in which an probability that a profit designated by an ordering person is ensured is the highest.

Also, the order quantity determination device 10 according to this embodiment receives, as a condition regarding a profit, designation of a profit that is to be ensured, a first probability with which the profit is to be ensured, and a second probability with which the profit is maximized. The order quantity determination device 10 obtains, for each order plan, a probability with which the designated profit is able to be ensured and a profit that is ensured with the designated second probability. The order quantity determination device 10 outputs an order plan, among order plans that satisfy a condition that a probability with which the profit is able to be ensured is the first probability, in which an ensured profit is the highest. Thus, the order quantity determination device 10 may obtain an order plan in which the profit designated by an ordering person and the first probability with which the profit is to be ensured are satisfied, and also, the profit ensured with the second probability designated by the ordering person is the highest.

Also, the order quantity determination device 10 according to this embodiment receives, as a condition regarding a profit, designation of a first profit that is to be ensured, a probability with which the profit is to be ensured, and a second profit that is desired to be ensured. The order quantity determination device 10 obtains, for each order plan, a probability with which the designated first profit is able to be ensured and a probability that the designated second profit is ensured. The order quantity determination device 10 outputs an order plan, among order plans that satisfy a condition that the probability with which the profit is able to be ensured is the designated probability, in which the probability that the profit is ensured is the highest. Thus, the order quantity determination device 10 may obtain an order plan in which the first profit designated by the ordering person and the probability with which the profit is to be ensured are satisfied and also the probability that the second profit designated by the ordering person is ensured is the highest.

### Second Embodiment

An embodiment related to a device disclosed herein has been described so far, but the disclosed technique may be implemented in various embodiments other than the above-described embodiment. Therefore, other embodiments will be described below.

For example, in the above-described embodiment, as illustrated in FIG. 5, for demand quantities in prediction periods, demand quantities of a previous period are added to prediction, and an occurrence probability of a demand quantity in each prediction period is predicted in a tree-like manner. In the above-described embodiment, a case where, for each pathway, occurrence probabilities of demand quantities in prediction periods of the pathway are multiplied and thus an occurrence probability of a demand of the pathway is obtained has been described, but the present disclosure is not limited thereto. For example, an occurrence probability of a demand quantity in each prediction period may be obtained, the occurrence probabilities corresponding to the demand quantities in the prediction periods may be multiplied, and thereby an occurrence probability of a demand may be obtained. An occurrence probability of a demand quantity of each prediction period may be predicted from past demands, may be predicted by another system, and may be set by an administrator. Also, as the occurrence probability of a demand quantity in each predication zone, an occurrence probability of a single common demand quantity may be used, and an occurrence probability of an individual demand quantity predicted for each prediction period may be used.

Also, in the above-described embodiment, a case where, as constraint conditions, a maximum order quantity, a maximum inventory quantity, and a probability of out-of-stock occurrence are used has been described, but the present disclosure is not limited thereto. Other constraint conditions of various kinds may be added. Constraint conditions may be externally settable, for example, by designation of an ordering person, and may be fixed by a system.

Also, each component element of each unit illustrated in the drawings is function conceptual and may not be physically configured as illustrated in the drawings. That is, specific embodiments of disintegration and integration of each unit are not limited to those illustrated in the drawings, and all or some of the units may be disintegrated/integrated functionally or physically in an arbitrary unit in accordance with various loads, use conditions, and the like. For example, processing sections, such as the collection section 40, the reception section 41, the prediction section 42, the calculation section 43, and the output section 44, may be integrated, as appropriate. Also, processing of each processing section may be divided to processes of a plurality of processing sections, as appropriate. Furthermore, the whole or a part of each processing function performed by each processing section may be realized by a CPU and a program that is analyzed and executed by the CPU, or may be realized as a hardware of a wired logic.

[Order Quantity Determination Program]

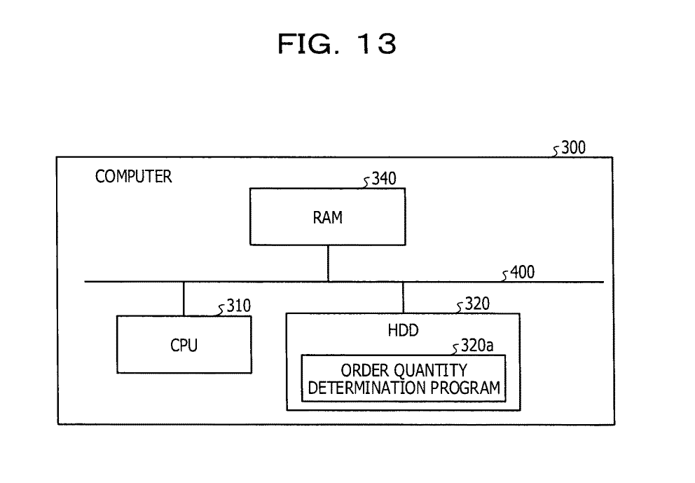

Various types of processing described in the above-described embodiments may be realized by causing a computer system, such as a personal computer, a work station, and the like, to execute a program prepared in advance. Then, an example of a computer system that executes a program having similar functions to those of the above-described embodiments will be described below. FIG. 13 is a diagram illustrating a computer that executes an order quantity determination program.

As illustrated in FIG. 13, a computer 300 includes a central processing unit (CPU) 310, a hard disk drive (HDD) 320, and a random access memory (RAM) 340. The computer 300, the CPU 310, the HDD 320, and the RAM 340 are coupled to one another via a bus 400.

An order quantity determination program 320a that exhibits similar functions to those of the collection section 40, the reception section 41, the prediction section 42, the calculation section 43, and the output section 44 are stored in advance in the HDD 320. Note that the order quantity determination program 320a may be divided, as appropriate.

Also, the HDD 320 stores various types of information. For example, the HDD 320 stores an OS and various types of data used for determining an order quantity.

Then, the CPU 310 reads and executes the order quantity determination program 320a from the HDD 320, and thereby, executes similar operations to those of the processing sections of the above-described embodiments. That is, the order quantity determination program 320a executes similar operations to those of the collection section 40, the reception section 41, the prediction section 42, the calculation section 43, and the output section 44.

Note that there may be cases where the above-described order quantity determination program 320a is not stored in advance in the HDD 320.

For example, a program is stored in advance in a “portable physical medium”, such as a flexible disk (FD), a CD-ROM, a DVD disk, a magneto-optical disk, an IC card, and the like, which is inserted in the computer 300. Then, the computer 300 may read the program from the physical medium and execute the program.

Furthermore, a program is stored in advance in another computer (or a server) coupled to the computer 300 via a public line, the Internet, a LAN, or a WAN. Then, the computer 300 may read the program from the another server and execute the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer readable medium having stored therein a program that causes a computer to execute a process, the process comprising:
receiving a condition regarding a constraint condition of a product;
acquiring past requirement values for the product;
predicting, for each of a plurality of periods, requirement value for the product by calculating the requirement value for each of the plurality of periods based on the acquired past requirement values;
generating, based on the predicted requirement value for each of the plurality of periods, a probability distribution of the constraint condition for each of a plurality of requested arrangements each of which indicates requested quantities of the product for each of the plurality of periods; and
outputting at least one of the plurality of requested arrangements, based on the generated probability distribution and the received condition regarding the constraint condition.

2. The non-transitory computer readable medium according to claim 1, wherein the process further includes:
combining predicted requirements for the product, which are predicted for the plurality of periods,
obtaining an occurrence probability for each combination of the predicted requirements in the plurality of periods, and
calculating, based on an estimated result in each combination of the predicted requirements and the obtained occurrence probability, a probability distribution of the constraint condition for each of the requested arrangements.

3. The non-transitory computer readable medium according to claim 2, wherein
the process further includes:
obtaining, based on the calculated probability distribution, a relationship between a constraint condition and a probability that the constraint condition is satisfied for each of the requested arrangements, and
the outputted at least one of the plurality of requested arrangements further satisfies the condition regarding a constraint condition in the relationship.

4. The non-transitory computer readable medium according to claim 1, wherein
the process further includes:
receiving, as the condition regarding the constraint condition, a designation of a probability with which an estimated result is maximized, and
obtaining a constraint condition that satisfies the designated probability for each of the requested arrangements, and
the outputted at least one of the plurality of requested arrangements further includes the maximized estimated result.

5. The non-transitory computer readable medium according to claim 1, wherein
the process further includes:
receiving, as the condition regarding the constraint condition, a designation of a constraint condition that is to be required, and
obtaining a probability that the designated constraint condition is required for each of the requested arrangements, and
the outputted at least one of the plurality of requested arrangements is outputted based on the obtained probability that is highest among the obtained probability for each of the requested arrangements.

6. The non-transitory computer readable medium according to claim 1, wherein
the process further includes:
receiving, as the condition regarding the constraint condition, a designation of a constraint condition that is to be satisfied, a first probability with which an estimated result is to be satisfied, and a second probability with which an estimated result is maximized, and
obtaining, for each of the requested arrangements, a probability with which the designated constraint condition is to be ensured and a constraint condition that satisfies the designated second probability, and
the outputted at least one of the plurality of requested arrangements is outputted based on the constraint condition that satisfies the first probability.

7. The non-transitory computer readable medium according to claim 1, wherein
the process further includes:
receiving, as the condition regarding the constraint condition, a designation of a first constraint condition that is to be satisfied, a probability with which the constraint condition is to be satisfied, and a second constraint condition that is to be satisfied, and
obtaining, for each of the requested arrangements, a probability with which the designated first constraint condition is satisfied and a probability that the designated second constraint condition is satisfied, and
the outputted at least one of the plurality of requested arrangements is outputted based on a probability with the constraint condition that satisfies the designated probability.

8. A system comprising:
circuitry configured to
receive a condition regarding a constraint condition of a product,
acquire past requirement values for the product,
predict, for each of a plurality of periods, requirement value for the product by calculating the requirement value for each of the plurality of periods based on the acquired past requirement values,
generate, based on the predicted requirement value for each of the plurality of periods, a probability distribution of the constraint condition for each of a plurality of requested arrangements each of which indicates requested quantities of the product for each of the plurality of periods, and
output at least one of the plurality of requested arrangements, based on the generated probability distribution and the received condition regarding the constraint condition.

9. The system according to claim 8, wherein
the circuitry is further configured to
combine predicted requirements for the product, which are predicted for the plurality of periods,
obtain an occurrence probability for each combination of the predicted requirements in the plurality of periods, and
calculate, based on an estimated result in each combination of the predicted requirements and the obtained occurrence probability, a probability distribution of the constraint condition for each of the requested arrangements.

10. The system according to claim 9, wherein
the circuitry is further configured to obtain, based on the calculated probability distribution, a relationship between a constraint condition and a probability that the constraint condition is satisfied for each of the requested arrangements, and
the outputted at least one of the plurality of requested arrangements further satisfies the condition regarding a constraint condition in the relationship.

11. The system according to claim 8, wherein
the circuitry is further configured to
receive, as the condition regarding the constraint condition, a designation of a probability with which an estimated result is maximized, and
obtain a constraint condition that satisfies the designated probability for each of the requested arrangements, and
the outputted at least one of the plurality of requested arrangements further includes the maximized estimated result.

12. The system according to claim 8, wherein
the circuitry further configured to
receive, as the condition regarding the constraint condition, a designation of a constraint condition that is to be required, and
obtain a probability that the designated constraint condition is required for each of the requested arrangements, and
the outputted at least one of the plurality of requested arrangements is outputted based on the obtained probability that is highest among the obtained probability for each of the requested arrangements.

13. The system according to claim 8, wherein
the circuitry is further configured to
receive, as the condition regarding the constraint condition, a designation of constraint condition that is to be satisfied, a first probability with which an estimated result is to be satisfied, and a second probability with which an estimated result is maximized, and
obtain, for each of the requested arrangements, a probability with which the designated constraint condition is to be ensured and a constraint condition that satisfies the designated second probability, and
the outputted at least one of the plurality of requested arrangements is outputted based on the constraint condition that satisfies the first probability.

14. The system according to claim 8, wherein
the circuitry is further configured to
receive, as the condition regarding the constraint condition, a designation of a first constraint condition that is to be satisfied, a probability with which the constraint condition is to be satisfied, and a second constraint condition that is desired to be satisfied, and
obtain, for each of the requested arrangements, a probability with which the designated first constraint condition is satisfied and a probability that the designated second constraint condition is satisfied, and
the outputted at least one of the plurality of requested arrangements is outputted based on a probability with the constraint condition that satisfies the designated probability.

15. A method comprising:
receiving, by circuitry, a condition regarding a constraint condition of a product;
acquiring, by the circuitry, past requirement values for the product;
predicting, for each of a plurality of periods, by the circuitry, requirement value for the product by calculating the requirement value for each of the plurality of periods based on the acquired past requirement values;
generating, by the circuitry, based on the predicted requirement value for each of the plurality of periods, a probability distribution of the constraint condition for each of a plurality of requested arrangements each of which indicates requested quantities of the product for each of the plurality of periods; and
outputting at least one of the plurality of requested arrangements, based on the generated probability distribution and the received condition regarding the constraint condition.

16. The method according to claim 15, further comprising:
combining predicted requirements for the product, which are predicted for the plurality of periods;
obtaining an occurrence probability for each combination of the predicted requirements in the plurality of periods;
calculating, based on an estimated result in each combination of the predicted requirements and the obtained occurrence probability, a probability distribution of the constraint condition for each of the requested arrangements; and
obtaining, based on the calculated probability distribution, a relationship between a constraint condition and a probability that the constraint condition is satisfied for each of the requested arrangements, wherein
the outputted at least one of the plurality of requested arrangements further satisfies the condition regarding a constraint condition in the relationship.

17. The method according to claim 15, further comprising:
receiving, as the condition regarding the constraint condition, a designation of a probability with which an estimated result is maximized; and
obtaining a constraint condition that satisfies the designated probability for each of the requested arrangements, wherein
the outputted at least one of the plurality of requested arrangements further includes the maximized estimated result.

18. The method according to claim 15, further comprising:
receiving, as the condition regarding the constraint condition, a designation of a constraint condition that is to be required; and
obtaining a probability that the designated constraint condition is required for each of the requested arrangements, wherein
the outputted at least one of the plurality of requested arrangements is outputted based on the obtained probability that is highest among the obtained probability for each of the requested arrangements.

19. The method according to claim 15, further comprising:
receiving, as the condition regarding the constraint condition, a designation of a constraint condition that is to be satisfied, a first probability with which an estimated result is to be satisfied, and a second probability with which an estimated result is maximized; and
obtaining, for each of the requested arrangements, a probability with which the designated constraint condition is to be ensured and a constraint condition that satisfies the designated second probability, wherein
the outputted at least one of the plurality of requested arrangements is outputted based on the constraint condition that satisfies the first probability.

20. The method according to claim 15, further comprising:
receiving, as the condition regarding the constraint condition, designation of a first constraint condition that is to be satisfied, a probability with which the constraint condition is to be satisfied, and a second constraint condition that is to be satisfied; and
obtaining, for each of the requested arrangements, a probability with which the designated first constraint condition is satisfied and a probability that the designated second constraint condition is satisfied, wherein
the outputted at least one of the plurality of requested arrangements is outputted based on a probability with the constraint condition that satisfies a designated probability.
